(19) United States
(12) Patent Application Publication
(10) Pub. No.: US 2026/0077353 A1
(43) Pub. Date: Mar. 19, 2026

(54) DILUTION DEVICE

(71) Applicant: KATHOLIEKE UNIVERSITEIT LEUVEN, Leuven (BE)

(72) Inventors: Jeroen LAMMERTYN, Huldenberg (BE); Dries VLOEMANS, Wezemaal (BE); Francesco DAL DOSSO, Leuven (BE)

(21) Appl. No.: 18/861,654

(22) PCT Filed: May 2, 2023
(86) PCT No.: PCT/EP2023/061569

§ 371 Date: Oct. 30, 2024

(30) Foreign Application Priority Data
May 2, 2022 (EP) 22171144.3

(51) Int. Cl. B01L 3/00

(52) U.S. Cl. CPC B01L 3/502723; B01L 3/502738; B01L 2200/16; B01L 2400/0406; B01L 2400/0688

(57) ABSTRACT

A fluid conduit device is for merging a first liquid with a second liquid.

### FIELD OF THE INVENTION

The present invention relates to a fluid conduit device for displacing and merging liquid plugs. The invention further relates to microfluidic devices comprising said fluid conduit devices.

### BACKGROUND OF THE INVENTION

Reagent mixing and liquid dilutions are standard fluid operations needed during sample preparation of many biochemical assays such as immunological assays (e.g., ELISA) and nucleic acid amplification assays (e.g., PCR). Although these operations are straightforward to perform in laboratory settings through micro pipetting, their implementation in lab-on-a-chip (LOC) microfluidic devices often involves complex valving/venting and pumping mechanisms. The need for ancillary equipment restricts the use of such microfluidic systems only to well-equipped laboratory settings that are operated by trained personnel. Consequently, there is a need for simple solutions to enable the merging of liquid plugs without requiring actuation.

EP2975133 discloses a microchannel device for realizing an effective manipulation of a tiny amount of liquid. The microchannel device includes an upstream channel portion configured to allow an upstream liquid plug and a gas to flow therethrough; a downstream channel portion configured to allow a downstream liquid plug and a gas to flow therethrough; a liquid holding portion provided between a downstream end portion of the upstream channel portion and an upstream end portion of the downstream channel portion, the liquid holding portion being configured to hold a main liquid plug therein, and a gas bypass channel portion provided so as to bypass the liquid holding portion from the downstream end portion of the upstream channel portion to the upstream end portion of the downstream channel portion, the gas bypass channel portion being configured to allow the gas to flow therethrough in a state in which the liquid holding portion holds the mail liquid plug. Although the device may be efficient for sampling a tiny amount of the liquid a short time intervals a plurality of times, it does not allow to efficiently mix larger amounts of liquids.

### SUMMARY

In a first aspect, the present invention relates to a fluid conduit device comprising,
an inlet;
a merging intake duct, downstream of, and in fluid communication with, the inlet;
a first retention duct configured to resist entry of liquid into the duct and/or exit of liquid from the duct, downstream of, and in fluid communication with, the merging intake duct;
a liquid chamber, downstream of, and in fluid communication with, the first retention duct;
a second retention duct configured to resist entry of liquid into the duct and/or exit of liquid from the duct, downstream of, and in fluid communication with, the liquid chamber;
an exit duct, downstream of, and in fluid communication with, the second retention duct;
a bypass duct comprising,
   a bypass duct inlet opening into the merging intake duct;
   a bypass duct outlet opening into the exit duct;
   a first liquid-phobic liquid barrier, located further downstream of the bypass duct inlet to allow entry of liquid in the part of the bypass duct between the bypass duct inlet and said first liquid-phobic liquid barrier; and,
   a second liquid-phobic liquid barrier, located next to the bypass duct outlet to prevent entry of liquid in the bypass duct through said bypass duct outlet;
and, an outlet.

In embodiments, the fluid conduit device of the invention is for merging a first liquid with a second liquid. In embodiments, the fluid conduit device of the invention is for merging a first liquid with a second liquid in a microfluidic device.

In embodiments, the liquid chamber is filled with a second liquid.

In embodiments, the first liquid-phobic liquid barrier and/or the second liquid-phobic liquid barrier, comprises, or consists of, a liquid-phobic porous substrate.

In embodiments, the first retention duct and/or the second retention duct further comprise a fluid resistance, preferably a geometric retention valve and/or a liquid-phobic surface treatment.

In embodiments, the fluid conduit device of the invention comprises a fluidic network, in fluid communication with the fluid conduit device through the inlet or the outlet and wherein said fluidic network comprises means, preferably a pump, to draw in and/or push liquid into the fluid conduit. In embodiments, said pump is a capillary pump.

In embodiments, the fluid conduit device of the invention further comprises a liquid-philic liquid barrier in the part of the bypass duct between the bypass duct inlet and said first liquid-phobic liquid barrier.

In embodiments, the liquid-philic liquid barrier comprises or consists of liquid-philic porous material.

In embodiments, the fluid conduit device of the invention further comprises:
an upstream entry duct downstream of, and in fluid communication with, the inlet;
a metering duct, wherein said metering duct,
   (i) is downstream of, and in fluid communication with, the upstream entry duct;
   (ii) is upstream of, and in fluid communication with, the merging intake duct; and,
   (iii) comprises a first burst valve, located to allow the entry of a known volume of the first liquid in the parts and of the metering duct upstream of said first burst valve;
and, a waste duct, comprising
   a waste duct inlet opening into the upstream entry duct, wherein the downstream end of the upstream entry duct, the intake part of the waste duct and the intake part of the metering duct form a 3-way duct junction;
   a waste duct outlet opening into the part of the bypass duct located between the first liquid-phobic liquid barrier and the bypass duct outlet;
   a second burst valve located in the intake part of the waste duct to prevent entry of the first liquid in the waste duct before the complete filling of the part of the metering duct upstream of the first burst valve; and,
   a third liquid-phobic liquid barrier located to allow the entry of the excess of first liquid in the parts of the waste duct upstream of said third liquid-phobic barrier after bursting of said excess of first liquid through the second burst valve;
and, wherein the burst pressure of said second burst valve is inferior to the burst pressure of said first burst valve.

In embodiments, the intake part of the metering duct is a retention duct configured to resist entry of liquid into the duct and/or exit of liquid from the duct.

In embodiments, the third liquid-phobic liquid barrier, comprises, or consists of, a liquid-phobic porous substrate.

The present invention further relates to a fluidic device comprising a fluid conduit device of the invention.

In embodiments, the fluidic device is a microfluidic device.

In a second aspect, the present invention further relates to a method for merging a first liquid with a second liquid comprising the steps of
a) filling the liquid chamber of the fluid conduit device of the invention with the second liquid;
b) displacing the first liquid into said fluid conduit device of the invention; and,
c) merging said first liquid with said second liquid.

The present invention further relates to a method for merging a first liquid with a second liquid comprising the steps of
a. displacing the first liquid into the fluid conduit device of the invention; and,
b. merging said first liquid with said second liquid.

In embodiments of the method of the invention, the step of merging the first liquid with the second liquid does not require external actuation and/or does not require externally actuated or actuatable active systems such as a valve and/or a vent fitted with an actuator.

In a third aspect, the present invention provides the use of the fluid conduit device according to embodiments of the first aspect for merging a first liquid with a second liquid.

### BRIEF DESCRIPTION OF THE DRAWINGS

FIG. 1 is a drawing of the fluid conduit device; grey area represents the first liquid [101]; dashed areas represent the liquid-phobic liquid barriers; black area represents the second liquid [102]. The liquid [102] is present in the liquid chamber [107].

FIG. 2, including FIG. 2(a) to 2(e), is a drawing illustrating the different steps, a) to e), of the working principle of the fluid conduit device shown in FIG. 1; grey area represents the first liquid [101]; dashed areas represent the liquid-phobic liquid barriers; black area represent the second liquid [102]; solid arrow shows liquid displacement; dashed arrow shows air displacement; solid T-shaped lines shows blocking of liquid displacement; dashed T-shaped lines show blocking of air displacement. References to individual elements of the fluid conduit device are identical to that in FIG. 1.

FIG. 3, including FIGS. 3(a) and 3(b), is a drawing illustrating how n fluid conduit devices shown in FIG. 1—indicated as 1, 2 and n—can be serially arranged to successfully merge the first liquid [101] with several plugs of second liquid [102] indicated as [102a], [102b], [102n]. The lightest grey area represents the first liquid [101]; dashed areas represent the liquid-phobic liquid barriers; black area and dark grey areas ([102a], [102b] and [102n]) represent the second liquid [102]; solid arrow shows liquid displacement; dashed arrow shows air displacement; solid T-shaped lines shows blocking of liquid displacement; dashed T-shaped lines show blocking of air displacement. References to individual elements of the fluid conduit device are identical to that in FIG. 1.

FIG. 4 is a drawing of the fluid conduit device comprising a liquid-philic liquid barrier [115]; grey area represents the first liquid [101]; dashed areas represent the liquid-phobic liquid barriers; black area represents the second liquid [102]. The liquid [102] is present in the liquid chamber [107].

FIG. 5, including FIG. 5(a) to 5(i), is a drawing illustrating the different steps, a) to i), of the working principle of the fluid conduit device shown in FIG. 4; grey area represents the first liquid [101]; dashed areas represent the liquid-phobic liquid barriers; black area represent the second liquid [102]; solid arrow shows liquid displacement; dashed arrow shows air displacement; solid T-shaped lines shows blocking of liquid displacement; dashed T-shaped lines show blocking of air displacement. References to individual elements of the fluid conduit device are identical to that in FIG. 4.

FIG. 6 is a drawing of the fluid conduit device comprising a metering module; mid-grey area [101] represents the first liquid [101]; dashed areas represent the liquid-phobic liquid barriers; black area represent the second liquid [102]; lightest grey area represents the second burst valve [123]; dark grey area represents the first burst valve [118]; The liquid [102] is present in the liquid chamber [107].

FIG. 7, including FIG. 7(a) to 7(g), is a drawing illustrating the different steps, a) to g), of the working principle of the fluid conduit device shown in FIG. 6; mid-grey area [101] represents the first liquid [101]; dashed areas represent the liquid-phobic liquid barriers; black area represent the second liquid [102]; lightest grey area represents the second burst valve [123]; dark grey area represents the first burst valve [118]; solid arrow shows liquid displacement; dashed arrow shows air displacement; solid T-shaped lines show blocking of liquid displacement; dashed T-shaped lines show blocking of air displacement. References to individual elements of the fluid conduit device are identical to that in FIG. 6.

### DETAILED DESCRIPTION

Here the inventors have developed a fluid conduit device allowing, without requiring actuation and/or without requiring active systems, the merging of a first liquid [101] with a second liquid [102].

With “without requiring actuation” in the context of the present invention is meant that no external actuation, e.g. user intervention, is required to manipulate, e.g. open or close, valves and/or vents. The first liquid and the second liquid may be moved through the fluid conduit device under capillary forces, which may be considered a kind of internal actuation. Similarly, “without requiring active systems” means that no external actuators are provided, fitted on and meant for actuating valves or vents.

The present invention hence relates to a fluid conduit device for merging a first liquid [101] with a second liquid [102]. In embodiments the fluid conduit device of the invention is for displacing a first liquid [101] in an upstream to downstream direction and merging it with a second liquid [102]. The fluid conduit device may be used to manipulate, or displace, a plug, or discrete volume, of the first liquid [101] toward a plug, or discrete volume, of a second liquid [102] to place the plug, or discrete volume, of the first liquid [101] in contact with the plug, or discrete volume, of a second liquid [102] resulting in a single volume of liquid, the merged liquids plug.

In embodiments, the fluid conduit device of the invention is for merging a first liquid [101] with a second liquid [102] in a millifluidic device or a microfluidic device, preferably in a microfluidic device. In embodiments, the fluid conduit device of the invention is for displacing a first liquid [101] in an upstream to downstream direction and merging it with a second liquid [102] in a millifluidic device or a microfluidic device, preferably in a microfluidic device.

In embodiments, the fluid conduit device of the invention comprises an inlet [103].

The term “inlet” is used herein in reference to an opening that may be used for intake. The inlet [103] hence may be used for the intake of the first liquid [101] into the fluid conduit device of the invention.

In embodiments, the inlet [103] is connected to an upstream fluidic network. In embodiments, the fluid conduit device of the invention comprises an upstream fluidic network.

In embodiments, the fluid conduit device comprises an outlet [104].

The term “outlet” is used herein in reference to an opening that may be used for outtake. The outlet [104] hence may be used for the outtake of the liquid plug resulting from the merging of the first liquid [101] with the second liquid [102].

In embodiments, the outlet [104] is connected to a downstream fluidic network. In embodiments the fluid conduit device of the invention comprises a downstream fluidic network.

The terms “upstream” and “downstream” are used herein in reference to the liquid flow direction from the entry of liquid into the fluid conduit device of the invention via the inlet [103] to the exit of liquid from the fluid conduit device of the invention via the outlet [104].

In embodiments, the upstream fluidic network comprises a reservoir containing the first liquid [101] and/or comprises a sample inlet.

In embodiments, the upstream fluidic network comprises means to push liquid into the fluid conduit device of the invention and/or the downstream fluidic network comprises means to pull liquid into the fluid conduit device of the invention and/or the fluid conduit device of the invention is configured to displace liquid by capillary forces. In embodiments, said means to push liquid into the fluid conduit device of the invention is a pump. In embodiments, said means to pull liquid into the fluid conduit device of the invention is a pump.

Examples of pumps that may be used in the context of the invention include, without being limited to, active pumps, such as syringes or pressure pumps and passive pumps such as capillary pumps. Pumps may be, without being limited to, millifluidic or microfluidic pumps.

In embodiments, said pump is a capillary pump.

In embodiments, the fluid conduit device comprises a merging intake duct [105]. In embodiments, the merging intake duct [105] is configured to transport fluids from the inlet [103] to the downstream part(s) of the fluid conduit device of the invention.

In embodiments, the merging intake duct [105] is located downstream of the inlet [103]. In embodiments, the merging intake duct [105] is in fluid communication with the inlet [103]. In embodiments, the merging intake duct [105] is located downstream of the inlet [103] and is in fluid communication with the inlet [103]. In embodiments, part or the entirety of, the merging intake duct [105] is a retention duct.

The term “retention duct” is used herein in reference to a duct configured to resist entry of liquid into the duct and/or exit of liquid from the duct and/or displacement of liquid within the duct. This can, for instance and without limitation, be achieved by using a duct with a cross-section small enough to act as a geometric retention valve. In embodiments, the retention duct is a microfluidic duct restriction.

In embodiments, the fluid conduit device of the invention comprises a first retention duct [106]. In embodiments, the first retention duct [106] is configured to transport fluids from the merging intake duct [105] to the downstream part(s) of the fluid conduit device of the invention.

In embodiments, the first retention duct [106] is located downstream of the merging intake duct [105]. In embodiments, the first retention duct [106] is in fluid communication with the merging intake duct [105]. In embodiments, the first retention duct [106] is located downstream of, and is in fluid communication with, the merging intake duct [105]. In embodiments, the first retention duct [106] is connected to the merging intake duct [105].

In embodiments, the fluid conduit device of the invention comprises a liquid chamber [107]. In embodiments, said liquid chamber [107] is filled, preferably entirely filled, with the second liquid [102]. In embodiments, said liquid chamber [107] comprises means to fill, preferably completely fill, the liquid chamber [107] with the second liquid [102]. In embodiments, said means to fill, preferably completely fill, the liquid chamber [107] is an opening that may be sealed after filling in the liquid chamber [107] with the second liquid [102].

In embodiments, the liquid chamber [107] is located downstream of the first retention duct [106]. In embodiments, the liquid chamber [107] is in fluid communication with the first retention duct [106]. In embodiments, the liquid chamber [107] is located downstream of, and is in fluid communication with, the first retention duct [106]. In embodiments, the liquid chamber [107] is connected to the first retention duct [106].

In embodiments, the fluid conduit device of the invention comprises a second retention duct [108]. In embodiments, the second retention duct [108] is configured to transport fluids from the liquid chamber [107] to the downstream part(s) of the fluid conduit device of the invention.

In embodiments, the second retention duct [108] is located downstream of the liquid chamber [107]. In embodiments, the second retention duct [108] is in fluid communication with the liquid chamber [107]. In embodiments, the second retention duct [108] is located downstream of, and is in fluid communication with, the liquid chamber [107]. In embodiments, the second retention duct [108] is connected to the liquid chamber [107].

In embodiments, the liquid chamber [107] is flanked by two retention ducts. In embodiments the liquid chamber [107] is flanked by the first retention duct [106] and the second retention duct [108]. In embodiments, the liquid chamber [107] is connected to the first retention duct [106] and the second retention duct [108]. The first retention duct [106] and the second retention duct [108] introduce local flow resistances and prevent the second liquid [105] from being manipulated by accident in the up- or downstream direction.

In embodiments, the first retention duct [106] is configured to resist liquid flow from the liquid chamber [107] to the upstream merging intake duct [105]. In embodiments, the second retention duct [108] is configured to resist liquid flow from the liquid chamber [107] to the downstream exit duct [109]. In embodiments, the first retention duct [106] and the second retention duct [108] are configured to resist liquid flow from the liquid chamber [107] to the upstream merging intake duct [105] and downstream exit duct [109]. The first retention duct [106] and/or the second retention duct [108] may, for instance and without limitation, be of cross-section narrow enough for the opening of said duct(s) to act as a geometric retention valve.

In embodiments, the opening of the first retention duct [106] into the liquid chamber [107] is configured to resist liquid flow from the liquid chamber [107] to the upstream merging intake duct [105]. In embodiments, the opening of the second retention duct [108] into the liquid chamber [107] is configured to resist liquid flow from the liquid chamber [107] to the downstream exit duct [109]. In embodiments, the opening of the first retention duct [106] and the opening of the second retention duct [108] are configured to resist liquid flow from the liquid chamber [107] to said upstream merging intake duct [105] and downstream exit duct [109]. The first retention duct [106] and/or the second retention duct [108] may, for instance and without limitation, be of cross-section narrow enough for the opening of said duct(s) to act as a geometric retention valve. It is withing the reach of the skilled artisan to adjust the size of the cross-section to achieve the desired effect, preferably the desired resistance.

In embodiments, the first retention duct [106] further comprises a fluid resistance. In embodiments, the second retention duct [108] further comprises a fluid resistance. In embodiments, the first retention duct [106] and the second retention duct [108] further comprise a fluid resistance. In embodiments, said fluid resistance is a geometric retention valve and/or a liquid-phobic, preferably hydrophobic, surface treatment.

When referring to material and/or surface treatment being liquid-phobic, it is within the reach of the skilled artisan to adapt said material and/or surface treatment to the nature (e.g. aqueous or non-aqueous) of the liquid being manipulated. “Liquid-phobic” in the context of the present invention thus does not refer to a material that would lack chemical affinity for any liquid, but is to be understood as a material lacking chemical affinity for the particular liquid being manipulated. A suitable material and/or surface treatment may be selected, depending on the intended use, i.e. on the intended liquid to be manipulated.

In embodiments, the fluid conduit device of the invention comprises an exit duct [109]. In embodiments, the exit duct [109] is configured to transport fluids from the second retention duct [108] to the downstream part(s) of the fluid conduit device of the invention.

In embodiments, the exit duct [109] is located downstream of the second retention duct [108]. In embodiments, the exit duct [109] is in fluid communication with the second retention duct [108]. In embodiments, the exit duct [109] is located downstream of, and is in fluid communication with, the second retention duct [108]. In embodiments, the exit duct [109] is connected to the second retention duct [108].

In embodiments, the fluid conduit device of the invention comprises a bypass duct [110]. The bypass duct [110] is configured to provide a temporary fluid connection between the merging intake duct [105] and the exit duct [109]. The bypass duct [110] thereby allows to displace the first liquid [101] inside the fluid conduit device of the invention and toward the liquid chamber [107] filled with the second liquid by positive pressure applied to the inlet [103] and/or negative pressure applied to the outlet [104] without displacing the second liquid [102].

In embodiments, the bypass duct [110] comprises a bypass duct inlet [111]. In embodiments the bypass duct inlet [111] opens into the merging intake duct [105]. In embodiments, the bypass duct [110] is connected to the merging intake duct [105] by the bypass duct inlet [111].

In embodiments, the internal volume of the part of the fluid conduit device of the invention located between the bypass duct inlet [111] and the inlet [107a] of the chamber [107] is minimized to prevent that a stable air plug separates the first liquid [101] from the second liquid [102] upon entry of the front the first liquid [101] in the liquid chamber [107]. In embodiments, the internal volume of the part of the fluid conduit device of the invention located between the bypass duct inlet [111] and the inlet [107a] of the chamber [107] is minimized to allow merging of the first liquid [101] with the second liquid [102] in the liquid chamber [107].

In embodiments, the downstream end of the merging intake duct [105], the intake of the bypass duct [110] and the intake of the first retention duct [106] form a 3-way duct junction and the internal volume of the first retention duct [106] is minimized to prevent that a stable air plug separates the first liquid [101] from the second liquid [102] upon entry of the front of the first liquid [101] in the liquid chamber [107]. In embodiments, the downstream end of the merging intake duct [105], the intake of the bypass duct [110] and the intake of the first retention duct [106] form a 3-way duct junction and the internal volume of the first retention duct [106] is minimized to allow merging of the first liquid [101] with the second liquid [102] in the liquid chamber [107].

In embodiments, the bypass duct inlet [111] and the intake of the first retention duct [106] are located to form a 3-way duct junction with the merging intake duct [105] and the internal volume of the first retention duct [106] is minimized to prevent that a stable air plug separates the first liquid [101] from the second liquid [102] upon entry of the front of the first liquid [101] in the liquid chamber [107]. In embodiments, the bypass duct inlet [111] and the intake of the first retention duct [106] are located to form a 3-way duct junction with the merging intake duct [105] and the internal volume of the first retention duct [106] is minimized to allow merging of the first liquid [101] with the second liquid [102] in the liquid chamber [107].

It is within the reach of the skilled artisan to adjust the dimensions of the fluid conduit device of the invention to ensure that the first liquid [101] and the second liquid [102] come into contact by preventing that an air plug separates the first liquid [101] from the second liquid [102].

In embodiments, the bypass duct [110] comprises a bypass duct outlet [112]. In embodiments the bypass duct outlet [112] opens into the exit duct [109]. In embodiments, the bypass duct [110] is connected to the exit duct [109] by the bypass duct outlet [112].

In embodiments, the bypass duct [110] comprises a first liquid-phobic liquid barrier [113].

The term “liquid-phobic liquid barrier” is used herein in reference to a gas-permeable, liquid-impermeable barrier. Once inserted within a microfluidic channel or duct and in contact with a liquid, it acts as a one-directional valve (diode valve), allowing the passage of air in both up- and downstream direction, but only allowing liquid to flow in the direction opposite to the liquid-phobic liquid barrier.

In embodiments, the first liquid-phobic liquid barrier [113] comprises, or consists of a liquid-phobic porous material. In embodiments, the first liquid-phobic liquid barrier [113] is a hydrophobic liquid barrier. In embodiments, the first liquid-phobic liquid barrier [113] comprises, or consists of, hydrophobic porous material.

Example of hydrophobic porous material that may be used in the context of the invention includes, without being limited to filter paper with inherent hydrophobic properties or filter paper that is treated hydrophobically.

In embodiments, the first liquid-phobic liquid barrier [113] is located further away from the bypass duct inlet [111], to allow entry of liquid into the bypass duct [110]. In embodiments, the first liquid-phobic liquid barrier [113] is located further away from the bypass duct inlet [111], to allow entry of liquid into the part [110a] of the bypass duct [110] between the bypass duct inlet [111] and the first liquid-phobic liquid barrier [113]. In this embodiment, the bypass duct [110] comprises two parts on each side of the first liquid-phobic liquid barrier [113], the part [110a] located between the bypass duct inlet [111] and the first liquid-phobic liquid barrier [113] and the part [110b] located between the first liquid-phobic liquid barrier and the bypass duct outlet [112]. The part [110a] located between the bypass duct inlet [111] and the first liquid-phobic liquid barrier [113] may also be referred to as a blocking duct as entry of liquid into said part prevents further gas circulation in the bypass duct. In embodiments, the bypass duct [110] comprises a second liquid-phobic liquid barrier [114].

In embodiments, the second liquid-phobic liquid barrier [114] comprises, or consists of a liquid-phobic porous material. In embodiments, the second liquid-phobic liquid barrier [114] is a hydrophobic liquid barrier. In embodiments, the second liquid-phobic liquid barrier [114] comprises, or consists of, hydrophobic porous material.

In embodiments, the second liquid-phobic barrier [114] is meant to prevent entry of liquid in the bypass duct [110] through the bypass duct outlet [112] and/or is located to prevent entry of liquid in the bypass duct [110] through the bypass duct outlet [112] and/or is located next to the bypass duct outlet [112] and/or is located in the outtake zone of the bypass duct [110].

In embodiments, the fluid conduit device of the invention further comprises a liquid-philic liquid barrier [115].

The term liquid-philic liquid barrier is used herein in reference to gas-permeable barrier that becomes gas-impermeable upon wetting with liquid. Once inserted within a microfluidic channel or duct and in contact with a liquid (aqueous liquid in the case of an hydrophilic barrier), it gets saturated and completely blocks the liquid and airflow in both up-and downstream directions. “Liquid-philic” in the context of the present invention thus does not refer to a material that would have chemical affinity for any liquid, but is to be understood as a material having chemical affinity for the particular liquid being manipulated. A suitable material and/or surface treatment may be selected, depending on the intended use, i.e. on the intended liquid to be manipulated.

In embodiments, the liquid-philic liquid barrier [115] comprises, or consists of, liquid-philic porous material. In embodiments, the liquid-philic liquid barrier [115] is hydrophilic. In embodiments, liquid-philic liquid barrier [115] comprises, or consists of, hydrophilic porous material.

Example of hydrophilic porous material that may be used in the context of the invention, including, without being limited to, cellulose paper.

When referring to material and/or surface treatment being liquid-philic, it is within the reach of the skilled artisan to adapt said material and/or surface treatment to the nature (e.g. aqueous or non-aqueous) of the liquid being manipulated.

In embodiments, the liquid-philic liquid barrier [115] is located in the bypass duct [110]. In embodiments, the bypass duct [110] further comprises a liquid-philic liquid barrier [115]. In embodiments, the liquid-philic liquid barrier [115] is located in the part [110a] of the bypass duct located between the bypass duct inlet [111] and the first liquid-phobic liquid barrier [113]. In embodiments, the liquid-philic liquid barrier [115] is located next to the first liquid-phobic liquid barrier [113]. In this embodiment, there is no space separating the liquid-philic liquid barrier [115] and the first liquid-phobic liquid barrier [113]. In embodiments, the liquid-philic liquid barrier [115] is located in the part [110a] of the bypass duct [110] located between the bypass duct inlet [111] and the first liquid-phobic liquid barrier [113] and the liquid-philic liquid barrier [115] is in direct contact with the first liquid-phobic liquid barrier [113].

In embodiments, the fluid conduit device of the invention is for metering and isolating a volume of a first liquid [101] and merging said metered and isolated volume of the first liquid [101] with a second liquid [102]. In embodiments, the fluid conduit device of the invention is for metering and isolating a volume of a first liquid [101] and merging said metered and isolated volume of the first liquid [101] with a second liquid [102] in a microfluidic device.

In embodiments, the fluid conduit device of the invention is for displacing a first liquid [101] in an upstream to downstream direction, metering and isolating a volume of said first liquid [101] and merging said metered and isolated volume of the first liquid [101] with a second liquid [102]. In embodiments, the fluid conduit device of the invention is for displacing a first liquid [101] in an upstream to downstream direction, metering and isolating a volume of said first liquid [101] and merging said metered and isolated volume of the first liquid with a second liquid [102] in a microfluidic device.

In embodiments, the fluid conduit device of the invention comprises an upstream entry duct [116]. In embodiments, the upstream entry duct [116] is configured to transport fluids from the inlet [103] to the downstream part(s) of the fluid conduit device of the invention.

In embodiments, the upstream entry duct [116] is located downstream of the inlet [103]. In embodiments, the upstream entry duct [116] is in fluid communication with the inlet [103]. In embodiments, the upstream entry duct [116] is located downstream of the inlet [103] and is in fluid communication with the inlet [103]. In embodiments, part or the entirety of, the upstream entry duct [116] is a retention duct.

In embodiments, the fluid conduit device of the invention comprises a metering duct [117]. In embodiments, the metering duct [117] is configured to transport fluid from the upstream entry duct [116] to the downstream part(s) of the fluid conduit device of the invention.

In embodiments, the metering duct [117] is located downstream of the upstream entry duct [116]. In embodiments, the metering duct [117] is in fluid communication with the upstream entry duct [116]. In embodiments, the metering duct [117] is located downstream of the upstream entry duct [116] and is in fluid communication with the upstream entry duct [116]. In embodiments, the metering duct [117] is connected to the upstream entry duct [116]. In embodiments, the intake part [117a] of the metering duct is a retention duct.

In embodiments, the metering duct [117] comprises a first burst valve [118].

The term “burst valve” is used herein as reference to a gas permeable valve preventing passage of liquid below a set pressure gradient (referred to herein as “burst pressure”). Once the burst pressure is reached, the liquid bursts through the burst valve and is able to flow downstream.

In embodiments, the first burst valve [118] is a liquid-phobic, preferably hydrophobic, burst valve or a geometric burst valve.

In embodiments, the first burst valve [118] is located to allow entry of a known volume of the first liquid [101] in the part [117a] and [117b] of the metering duct [117] upstream of said first burst valve [118]. The volume of the first liquid [101] allowed to fill the metering duct [117] up to the first burst valve [118] may be set to the desired volume of liquid to be merged with the second liquid [102]. It is within the reach of the skilled artisan to adjust the volume of the parts [117a] and [117b] of the metering duct upstream of said first burst valve [118] by changing its dimensions.

In embodiments, the metering duct [117] is located upstream of the merging intake duct [105]. In embodiments, the metering duct [117] is in fluid communication with the merging intake duct [105]. In embodiments, the metering duct [117] is located upstream of the merging intake duct [105] and is in fluid communication with the merging intake duct [105]. In embodiments, the metering duct [117] is connected to the merging intake duct [105]. In embodiments, the metering duct [117] is configured to transport fluid from the upstream entry duct [116] to the merging intake duct [105]. Liquid can only flow through the metering duct [117] from the upstream entry duct [116] to the merging intake duct [105] after the bursting of the first burst valve [118].

In embodiments, the fluid conduit device of the invention comprises a waste duct [119]. In embodiments, the waste duct [119] is configured to divert the excess of the first liquid [101] away from entering the metering duct [117] once said metering duct [117] is completely filled.

In embodiments, the waste duct [119] comprises a waste duct inlet [120]. In embodiments the waste duct inlet [120] opens into the upstream entry duct [116]. In embodiments, the waste duct [119] is connected to the upstream entry duct [116] by the waste duct inlet [120]. In embodiments, the waste duct inlet [120] opens in the upstream entry duct [116] and is located next to the metering duct inlet [121]. In embodiments, the waste duct inlet [120] opens in the upstream entry duct [116] and is located next to the metering duct inlet [121] to divert the excess of the first liquid [101] away from entering the metering duct [117] once said metering duct [117] is filled, preferably completely filled, with the first liquid [101]. In embodiments, the downstream end of the upstream entry duct [116], the intake part [119a] of the waste duct and the intake part [117a] of the metering duct [117] form a 3-way duct junction. In embodiments, the waste duct inlet and the metering duct inlet [121] are located to form a 3-way duct junction with the upstream entry duct [116].

In embodiments, the waste duct [119] comprises a waste duct outlet [122]. In embodiments, the waste duct outlet [122] opens into the part [110b] of the bypass duct [110] located between the first liquid-phobic liquid barrier [113] and the bypass duct outlet [112]. In embodiments, the waste duct outlet [122] opens into the part [110b] of the bypass duct [110] located between the first liquid-phobic liquid barrier [113] and the second liquid-phobic liquid barrier [112].

In embodiments, the waste duct [119] comprises a second burst valve [123]. In embodiments, the second burst valve [123] is located in the intake zone [119a] of, the waste duct [119] and/or close to the waste duct inlet [120] to prevent entry of the first liquid [101] into the waste duct [119] before the filling, preferably complete filling, with the first liquid [101], of the parts [117a] and [117b] of the metering duct upstream of the first burst valve [118]. In embodiments, the burst pressure of the second burst valve [123] is configured to burst upon the complete filling, preferably complete filling with the first liquid [101], of the parts [117a] and [117b] of the metering duct [117] upstream of the first burst valve [118]. In embodiments, the burst pressure of the second burst valve [123] is inferior to the burst pressure of the first burst valve [118].

In embodiments, the second burst valve [123] is a liquid-phobic, preferably hydrophobic, burst valve or a geometric burst valve.

In embodiments, the waste duct [119] comprises a third liquid-phobic liquid barrier [124]. In embodiments, the third liquid-phobic barrier [124] is located to allow entry of the excess volume of the first liquid [101] in the parts [119a] and [119b] of the waste duct [119] upstream of said third liquid-phobic liquid barrier [124]. Excess volume of the first liquid [101] is used herein in reference to the volume of the first liquid [101] in addition to that required to completely fill the parts [117a] and [117b] of the metering duct [117] upstream to the first burst valve [118]. In embodiments, the volume of the parts [119a] and [119b] of the waste duct [119] upstream of the third liquid-phobic liquid barrier [124] is configured to accommodate the excess volume of the first liquid [101] and/or is configured to prevent the excess volume of the first liquid [101] to enter the metering duct [117].

In embodiments, the third liquid-phobic liquid barrier [124] is located to allow the entry of the excess of first liquid [101] in the parts [119a] and [119b] of the waste duct [119] upstream of said third liquid-phobic barrier [124] after bursting of said excess of first liquid [101] through the second burst valve [123]. Once the excess of the first liquid [101] in the waste channel [119] reaches this third liquid-phobic barrier [124], it forces the isolated liquid in [117a] and [117b] to burst through the first burst valve [118] downstream towards the plug merging channel [105]

In embodiments, the third liquid-phobic liquid barrier [124] comprises, or consists of a liquid-phobic porous material. In embodiments, the third liquid-phobic liquid barrier [124] is a hydrophobic liquid barrier. In embodiments, the third liquid-phobic liquid barrier [124] comprises, or consists of, hydrophobic porous material.

The present invention further relates to a fluidic device comprising the fluid conduit device of the invention.

In embodiments, the fluidic device of the invention comprises at least two fluid conduit devices of the invention. The fluid conduit device of the invention may be arranged in series or in succession or in a series circuit, for successive (metering and) merging of discrete liquid plugs. In embodiments, the fluidic device comprises at least two fluid conduit devices of the invention arranged in series or in succession or in a series circuit.

In embodiments, the fluidic device of the invention is a millifluidic or microfluidic device. In embodiments, the fluidic device of the invention is a microfluidic device.

The present invention further relates to the use of the fluid conduit device of the invention for merging a first liquid with a second liquid and/or relates to the use of the fluid conduit device of the invention for displacing a first liquid [101] and merging it with a second liquid [102]. In embodiments, the present invention relates to the use of the fluid conduit device of the invention for metering and isolating a volume of a first liquid [101] and merging said metered and isolated volume of the first liquid with a second liquid [102].

The present invention further relates to a method for merging a first liquid [101] with a second liquid [102] and/or for displacing a first liquid [101] and merging it with a second liquid [102]. In embodiments, the method of the invention is for metering and isolating a volume of a first liquid [101] and merging said metered and isolated volume of first liquid with a second liquid [102].

In embodiments, the method of the invention comprises a step of filling the liquid chamber [107] of the fluid conduit device of the invention with the second liquid [102].

In embodiments, the method of the invention comprises a step of displacing the first liquid [101] into the fluid conduit device of the invention.

In embodiments, the method of the invention comprises a step of merging the first liquid [101] with the second liquid [102]. In embodiments, this step does not require external actuation and/or does not require externally actuatable or actuated systems.

### LIST OF REFERENCES USED

[101] first liquid
[102] second liquid
[103] inlet
[104] outlet
[105] merging intake duct
[106] first retention duct
[107] liquid chamber
[107a] inlet of the liquid chamber [107]
[108] second retention duct
[109] exit duct
[110] bypass duct
[110a] part of the bypass duct [110] between the bypass duct inlet [111] and the first liquid-phobic liquid barrier [113]
[110b] part of the bypass duct [110] between the first liquid-phobic liquid barrier [113] and the bypass duct outlet [112]
[111] bypass duct inlet
[112] bypass duct outlet
[113] first liquid-phobic liquid barrier
[114] second liquid-phobic liquid barrier
[115] liquid-philic liquid barrier
[116] upstream entry duct
[117] metering duct
[117a] intake part of the metering duct [117]
[117b] part of the metering duct upstream of the first burst valve [118] and downstream of the intake part [117a] of the metering duct [117]
[118] first burst valve
[119] waste duct
[119a] intake part of the waste duct [119]
[119b] part of the waste duct [119] upstream of third liquid-phobic liquid barrier [124] and downstream of the intake part [119a] of the waste duct [119]
[120] waste duct inlet
[121] metering duct inlet
[122] waste duct outlet
[123] second burst valve
[124] third liquid-phobic liquid barrier

### EXAMPLES

The present invention is further illustrated by the following examples.

### Example 1

### Microfluidic Air Bridge for Liquid Plug Merging

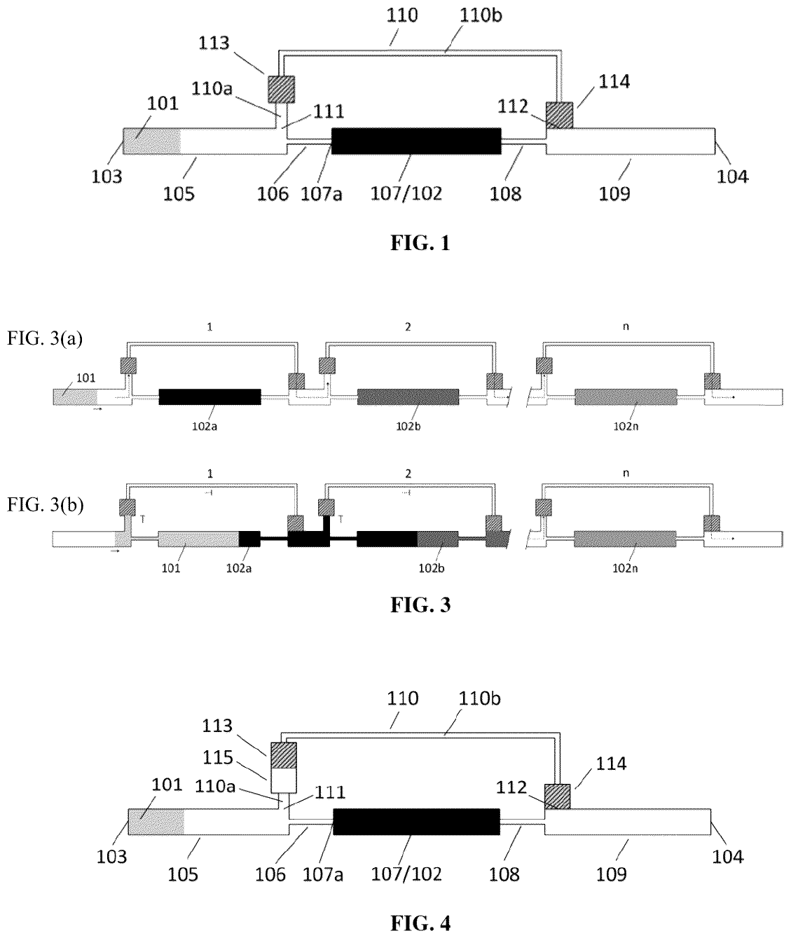

The design of the microfluidic device for merging a first liquid [101] with a second liquid [102] is illustrated by FIG. 1. The second liquid [102] may be a reagent or a dilution buffer. It comprises a bypass duct [110] that bridges a liquid chamber [107], prefilled with the second liquid [102], through an upstream liquid-phobic liquid barrier [113] and a downstream liquid-phobic liquid barrier [114]. These liquid-phobic liquid barriers can be hydrophobic porous elements (e.g., hydrophobically treated filter paper) or any other valving elements which allow air to pass but are impermeable to liquids. Consequently, the bypass duct [110] forms a fluidic connection between an upstream merging intake duct [105] and a downstream exit duct [109]. This air bridge ensures that the air volume separating the incoming first liquid [101] and the prefilled second liquid [102] can be removed by diverting it around the second liquid [102] contained in the liquid chamber [107]. The second liquid [102] within the liquid chamber [107] is flanked by an upstream first retention duct [106] and a downstream second retention duct [108]. These act as local flow resistors (i.e. geometric retention valves) and ensure that the second liquid [102] is not manipulated to the exit duct [109] when drawing in or pushing the first liquid [101] into the device. These retention ducts can be treated hydrophobic (contact angle ˜120°) or superhydrophobic (contact angle ˜160°) to increase the flow resistance even further. The bypass duct [110] is connected with the merging intake duct [105] via a bypass duct inlet [111] and connected with the exit duct [109] via the bypass duct outlet [112]. Right before plug merging, part of the incoming first liquid [101] enters the bypass duct [110] in the part [110a] between the bypass duct inlet [111] of the bypass duct [110] and the liquid-phobic liquid barrier [113] and thereby blocks the airflow between the merging intake duct [105] and exit duct [109]. After blocking of the upstream liquid-phobic liquid barrier [113] and thus the bypass duct [110], the incoming first liquid [101] and second liquid [102] merge and are manipulated to the exit duct [109] as a single merged plug. In the fluidic network downstream of the exit duct [109], connected via the outlet [104] of the device, the merged liquid plug can be further processed. This configuration is compatible with all microfluidic systems where a pressure gradient (positive or negative) is applied at the merging intake duct [105] or at the downstream exit duct [109] to manipulate (push or pull) the incoming first liquid [101] towards the exit duct [109]. Additionally, capillary action can also be used as driving source to merge the incoming first liquid [101] with the second liquid [102] and manipulate both to the exit duct [109]. Part of the merging intake duct [105] may be a retention duct. When the liquid is aqueous, the liquid-phobic liquid barrier [113] and [114] are hydrophobic.

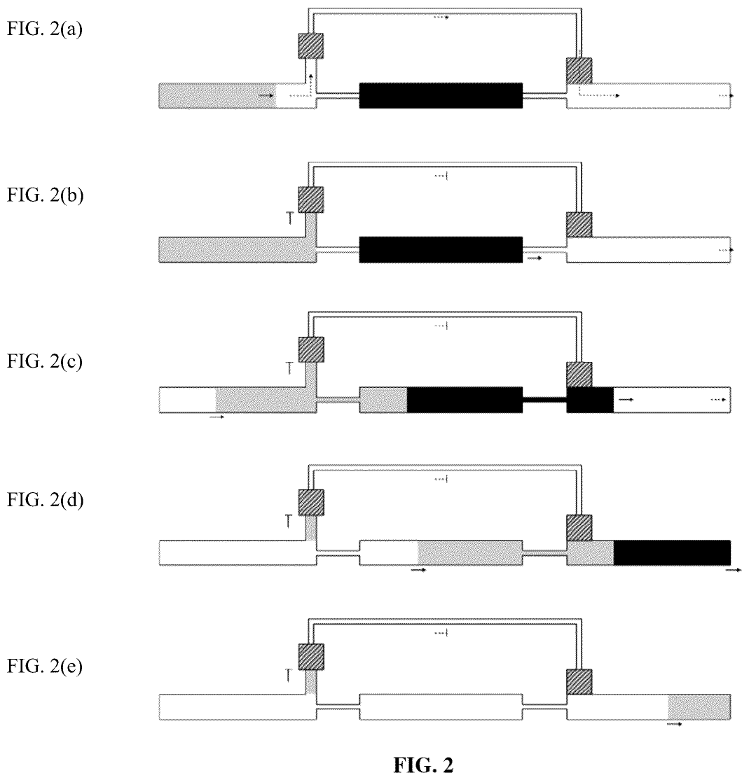

A detailed description of the different steps of the working principle is shown in FIG. 2a-e:
a) After entry of the incoming first liquid [101] through the device inlet [103], the air separating the incoming first liquid [101] in the merging intake duct [105] and the prefilled second liquid [102] in the liquid chamber [107] is removed and diverted to exit duct [109] through the bypass duct [110]. This can be achieved by applying a pressure gradient (positive—upstream pushing- or negative—downstream pulling) over the incoming first liquid [101] or through passive capillary forces. The second liquid [102] is kept stationary within the liquid chamber [107] as the bypass duct [110] ensures that no pressure gradient is applied over the second liquid [102]. The flanking retention ducts [106] and [108] also introduce an additional flow resistance to avoid accidental movement of the second liquid [102]. The scale of resistance can be tuned by adjusting the duct dimensions (size range: 10-500 μm) and surface properties (contact angle range: 10-160°).
b) Upon reaching the bypass duct inlet [111], part of the incoming first liquid [101] is forced into the bypass duct [110] toward the liquid-phobic liquid barrier [113].
c) From the moment, the incoming liquid reaches the liquid-phobic liquid barrier [113], the fluid connection (airflow) via the bypass duct [110] is sealed off, and both the incoming first liquid [101] and second liquid [102] are manipulated, after merging, toward the exit duct [109]. The liquid-phobic liquid barrier [114] is located into the bypass duct [110], next to the bypass duct outlet [112] to prevent entry of the merged liquid plugs into the bypass duct [110].
d) d-e) Once the receding air-liquid interface of the merged liquid plugs [101] and [102] passes the bypass duct inlet [111], the liquid fraction within the part [110a] of the bypass duct [110] located between the bypass duct inlet [111] and the liquid-phobic liquid barrier [113] becomes separated. This is an important feature as it prevents the fluidic connection (airflow) through the bypass duct [110] from opening again and ensures that the whole merged plug [101] and [102] is manipulated to the exit duct [109]. The merged liquid plug can be further processed in the downstream microfluidic network connected to the outlet [104] of the device (e.g., mixing, splitting, and the like).

The device for liquid plug merging can be serially coupled to successively merge the incoming first liquid [101] with several liquid plugs as illustrated by FIG. 3.

### Example 2

### Microfluidic Air Bridge for Liquid Plug Merging for Bidirectional Merged Plug Manipulation

The design of the device described in example 1 may be further adapted by the addition of a liquid-philic liquid barrier [115] positioned in front of the liquid-phobic liquid barrier [113] as illustrated in FIG. 4. This liquid-philic liquid barrier [115] is saturated with part of the incoming first liquid [101] and consequently permanently seals off the fluidic connection through the microfluidic bypass duct [110] in both the up- and downstream flow direction. This configuration allows to manipulate the merged first liquid [101] plug and second liquid [102] plug in the exit duct [109] back towards the merging intake duct [105]. When the liquid is aqueous, the liquid-philic liquid barrier [115] is hydrophilic and the liquid-phobic liquid barrier [113] and [114] are hydrophobic. This configuration is compatible with all microfluidic systems where a pressure gradient (positive or negative) is applied at the merging intake duct [105] or at the downstream exit duct [109] to manipulate (push or pull) the incoming first liquid [101] towards the exit duct [109].

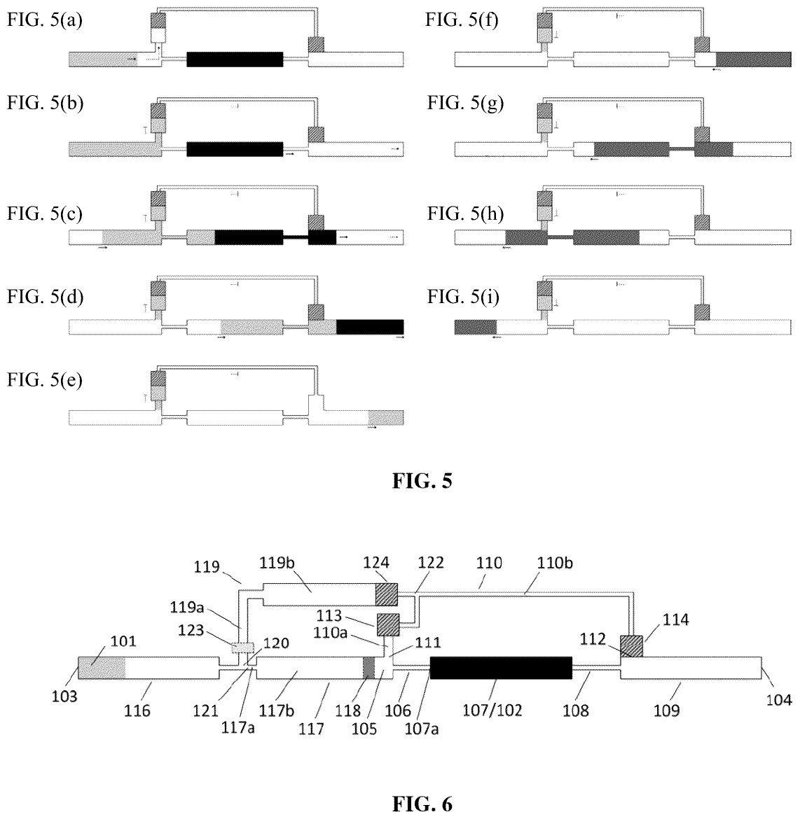

A detailed description of the different steps of the working principle is shown in FIG. 5a-i:
a) The air separating the incoming first liquid [101] in the merging intake duct [105] and the prefilled second liquid [102] in the liquid chamber [107] is removed and diverted to the exit duct [109] through a bypass duct [110]. This can be achieved by applying a pressure gradient (positive—upstream pushing or negative—downstream pulling) over the incoming first liquid [101] or through passive capillary forces. The second liquid [102] is kept stationary within the liquid chamber [107] as the bypass duct [110] ensures that no pressure gradient is applied over the second liquid [102]. The flanking retention ducts [106] and [108] also introduce an additional flow resistance to avoid accidental movement of the second liquid [102]. The scale of resistance can be tuned by adjusting the duct dimensions (size range: 10-500 μm) and surface properties (contact angle range: 10-160°).
b) Upon reaching the bypass duct inlet [111], the incoming first liquid [101] is forced into the bypass duct [110] where part of it gets absorbed by the liquid-philic liquid barrier [115]. Further movement of the absorbed liquid in the liquid-philic liquid barrier [115] in the bypass duct [110] is prevented by the liquid-phobic liquid barrier [113], which is in direct contact with the liquid-philic liquid barrier [115].
c) From the moment, the incoming liquid reaches the first liquid-phobic liquid barrier [113], the fluid connection (airflow) of the bypass duct [110] is sealed off, and both the incoming first liquid [101] and second liquid [102] are manipulated, after merging, toward the exit duct [109]. The liquid-phobic liquid barrier [114] is located into the bypass duct [110], next to the bypass duct outlet [112] to prevent entry of the merged liquid plug into the bypass duct [110].
d) d-e) Once the receding air-liquid interface of the merged liquid [101] and [102] passes the bypass duct inlet [111], the liquid fraction within the part [110a] of the bypass duct [110] located between the bypass duct inlet [111] and the liquid-phobic liquid barrier [113], part of which is absorbed by the liquid-philic liquid barrier [115], becomes separated. This is an important feature as it prevents the fluidic connection (airflow) through the bypass duct [110] from opening again and ensures that the whole merged plug [101] and [102] is manipulated to the exit duct [109].
e) f-g) After merging and downstream manipulation of the merged liquid plugs [101, 102] the flow direction can be reversed to manipulate the merged liquid plugs and/or other liquid reagents (e.g., washing buffer, substrate buffer) back through the reagent liquid chamber [107] towards the merging intake duct [105]
f) h-i) As the liquid-philic liquid barrier [115] is still saturated with part of the incoming first liquid [101] , it blocks the fluid connection (airflow) through the bypass duct [110]. Consequently, it is avoided that air diverts to the merging intake duct [105] via the bypass duct [110] once the receding liquid-air interface of the upstream moving merged liquid plug passes the bypass duct outlet [112]. In case this would occur, only part of the upstream moving merged liquid plug would be manipulated upstream, while the liquid fraction within the liquid chamber [107] would split off and remain stationary.

### Example 3

### Microfluidic Air Bridge for Liquid Dilution at Precise Dilution Factors

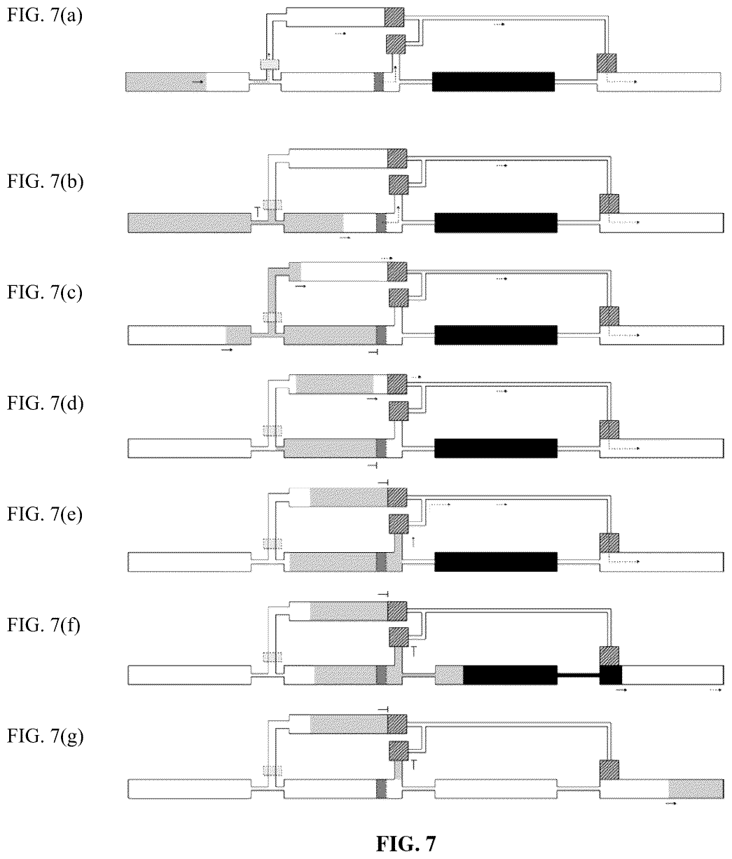

The design of the device described in example 1 may be further adapted by the addition of a metering circuit to measure a precise volume of liquid before plug merging as illustrated in FIG. 6. In this configuration, the device further comprises a metering duct [117], connected to the inlet [103] of the device by an upstream entry duct [116]. The metering duct inlet [121] is in connection with the other end of the upstream entry duct [116]. The other end of the metering duct [117] is connected to merging intake duct [105]. The device further comprises a waste duct [119], with the waste duct inlet [120] opening into the upstream entry duct [116], next to the metering duct inlet [121]. The other end of the waste duct [119] is in fluidic connection with the bypass duct [110] through a separating liquid-phobic liquid barrier [124]. The waste duct outlet [122] opens into the part [110b] of the bypass duct [110] located between the first liquid-phobic liquid barrier [113] and the second liquid-phobic liquid barrier [114]. A burst valve [123] (can either be hydrophobic burst valve or geometric burst valve) is located in the intake part [119a] of the waste duct [119] to introduce a temporary flow resistance and to force the incoming first liquid [101] into the metering duct [117]. A burst valve [118] is located in the metering duct [117] to allow entry of a determined volume of incoming first liquid [101] in the upstream parts [117a] and [117b] of the metering duct [117]. The burst valve [118] is configured with a larger burst pressure (and thus larger flow resistance) compared to the burst valve [123] in the waste duct [119]. Once the incoming first liquid [101] reaches the burst valve [118], the excess of incoming first liquid [101] bursts through the weaker burst valve [123] and is directed to the waste duct [119]. In this waste duct [119] the excess of the incoming first liquid [101] will finally reach a liquid-phobic liquid barrier [124], which will force the metered fraction of the incoming first liquid [101] through the burst valve [118]. The liquid-phobic liquid barrier [124] is located to allow the entry of the excess of first liquid [101] in the upstream parts [119a] and [119b] of the waste duct [119] after bursting of the first liquid [101] through the burst valve [123] subsequently to the complete filling of the upstream parts [117a] and [117b] of the metering duct [117]. Afterwards, the metered fraction of the incoming first liquid [101] will merge with the prefilled second liquid [102] in the downstream liquid chamber [107] following the same procedure as described in example 1. By tuning the dimensions and/or position of the burst valve [118] of the metering duct [117] and the liquid chamber [107] the dilution factor can be adjusted accordingly. Similarly, the dimension of the parts [119a] and [119b] of the waste duct upstream of the liquid-phobic liquid barrier [124] can be adjusted to accommodate the excess of incoming first liquid [101]. The burst valves [118] and [123] generate a flow resistance within the microfluidic network by introducing specific geometric restrictions (geometric burst valves), changes in surface properties (change in contact angle), or a combination of both.

Advantageously, the intake part [117a] of the metering duct [117] (next to its inlet [121]) is a retention duct, to avoid that part of the metered liquid volume in the metering duct [117] is dragged along to the waste duct [119] upon removing the volume excess of the first liquid [101] therein.

A detailed description of the different steps of the working principle is shown in FIG. 7a-g:
a) The incoming first liquid [101] is manipulated through the inlet [103] into the upstream entry duct [116] by applying a positive or negative pressure gradient.
b) Upon reaching the end of the upstream entry duct [116] where the waste duct inlet [120] and the metering duct inlet [121] are located, the burst valve [123] within the waste duct [119] introduces a flow resistance and consequently forces the incoming first liquid [101] in the metering duct [117].
c) When the advancing air-liquid interface of the incoming liquid plug in the metering duct [117] reaches the burst valve [118], the burst valve [123] bursts and the excess of the incoming liquid plug is directed to the waste duct [119]. The burst valve [118] introduces a higher flow resistance compared to the burst valve [123] in the waste duct [119].
d) When all the volume excess of the incoming first liquid [101] is directed to the waste duct [119], the metered fraction of the incoming first liquid [101] becomes isolated in the metering duct [117]. The volume of the metered fraction can be adjusted by altering the dimensions of the metering duct [117] and/or by adjusting the position of the burst valve [118].
e) Once the volume excess of the incoming first liquid [101] reaches the liquid-phobic liquid barrier [124] at the end waste duct [119], the metered fraction of the incoming first liquid [101] bursts through the burst valve [118] and is directed into the merging intake duct [105].
f) From the moment, the metered fraction of the first liquid [101] reaches the liquid-phobic liquid barrier [113], the fluid connection (airflow) of the bypass duct [110] is sealed off, and both the metered fraction of the incoming first liquid [101] and second liquid [102] within the liquid chamber [107] are manipulated to the exit duct [109].
g) Once the receding air-liquid interface of the merged liquid [101] and [102] passes the bypass duct inlet [111], the liquid fraction within the part [110a] of the bypass duct [110] located between the bypass duct inlet [111] and the liquid-phobic liquid barrier [113] becomes separated. This is an important feature as it prevents the fluidic connection through the microfluidic bypass duct [110] from opening again and ensures that the whole merged plug [101] and [102] is manipulated to the exit duct [109]. In the downstream microfluidic network connected to the outlet [104] of the device, the merged liquid plug can be further processed (e.g., mixing, splitting, etc.).

1.-15. (cancelled)

16. A fluid conduit device comprising,
an inlet;
a merging intake duct, downstream of, and in fluid communication with, the inlet;
a first retention duct configured to resist entry of liquid into the duct and/or exit of liquid from the duct, downstream of, and in fluid communication with, the merging intake duct;
a liquid chamber, downstream of, and in fluid communication with, the first retention duct;
a second retention duct configured to resist entry of liquid into the duct and/or exit of liquid from the duct, downstream of, and in fluid communication with, the liquid chamber;
an exit duct, downstream of, and in fluid communication with, the second retention duct;
a bypass duct comprising,
a bypass duct inlet opening into the merging intake duct;
a bypass duct outlet opening into the exit duct;
a first liquid-phobic liquid barrier, located further downstream of the bypass duct inlet to allow entry of liquid in the part of the bypass duct between the bypass duct inlet and said first liquid-phobic liquid barrier; and,
a second liquid-phobic liquid barrier, located next to the bypass duct outlet to prevent entry of liquid in the bypass duct through said bypass duct outlet;
and, an outlet.

17. The fluid conduit device according to claim 16, wherein the liquid chamber is filled with a second liquid.

18. The fluid conduit device according to claim 16, wherein the first liquid-phobic liquid barrier and/or the second liquid-phobic liquid barrier, comprises, or consists of, a liquid-phobic porous substrate.

19. The fluid conduit device according to claim 16, wherein the first retention duct and/or the second retention duct further comprise a fluid resistance.

20. The fluid conduit device according to claim 16, comprising a fluidic network, in fluid communication with the fluid conduit device through the inlet or the outlet and wherein said fluidic network comprises means to draw in and/or push liquid into the fluid conduit.

21. The fluid conduit device according to claim 16, wherein said fluid conduit device further comprises a liquid-philic liquid barrier in the part of the bypass duct between the bypass duct inlet and said first liquid-phobic liquid barrier.

22. The fluid conduit device according to claim 21, wherein the liquid-philic liquid barrier comprises or consists of liquid-philic porous material.

23. The fluid conduit device according to claim 16, wherein said fluid conduit device further comprises:
an upstream entry duct downstream of, and in fluid communication with, the inlet;
a metering duct, wherein said metering duct,
(i) is downstream of, and in fluid communication with, the upstream entry duct;
(ii) is upstream of, and in fluid communication with, the merging intake duct; and,
(iii) comprises a first burst valve, located to allow the entry of a known volume of the first liquid in the parts of the metering duct upstream of said first burst valve;
and, a waste duct, comprising
a waste duct inlet opening into the upstream entry duct, wherein the downstream end of the upstream entry duct, the intake part of the waste duct and the intake part of the metering duct form a 3-way duct junction;
a waste duct outlet opening into the part of the bypass duct located between the first liquid-phobic liquid barrier and the bypass duct outlet;
a second burst valve located in the intake part of the waste duct to prevent entry of the first liquid in the waste duct before the complete filling of the parts and of the metering duct upstream of the first burst valve; and,
a third liquid-phobic liquid barrier located to allow the entry of the excess of first liquid in the parts of the waste duct upstream of said third liquid-phobic barrier after bursting of said excess of first liquid through the second burst valve;
and wherein the burst pressure of said second burst valve is inferior to the burst pressure of said first burst valve.

24. The fluid conduit device according to claim 23, wherein the intake part of the metering duct is a retention duct configured to resist entry of liquid into the duct and/or exit of liquid from the duct.

25. The fluid conduit device according to claim 23, wherein the third liquid-phobic liquid barrier, comprises, or consists of, a liquid-phobic porous substrate.

26. A fluidic device, comprising a fluid conduit device according claim 16.

27. The fluidic device according to claim 26 wherein said fluidic device is a microfluidic device.

28. A method for merging a first liquid with a second liquid comprising the steps of
a. filling the liquid chamber of the fluid conduit device according to claim 16 with the second liquid;
b. displacing the first liquid into said fluid conduit device; and,
c. merging said first liquid with said second liquid.

29. The method according claim 28, wherein step (c) does not require external actuation and/or does not require an externally actuatable active system.

30. Use of the fluid conduit device according to claim 16, for merging a first liquid with a second liquid.
